(19) United States
(12) Patent Application Publication
(10) Pub. No.: US 2003/0153071 A1
(43) Pub. Date: Aug. 14, 2003

(54) Bioreactor for the microbial conversion of materials in lump and/or paste form

(76) Inventors: Jorg Sattler, Bad Lausick (DE); Dieter Sattler, Bad Lausick (DE)

Correspondence Address: PEARNE & GORDON LLP, 526 SUPERIOR AVENUE EAST, SUITE 1200, CLEVELAND, OH, 44114-1484, US

(21) Appl. No.: 10/312,201

(22) PCT Filed: Jun. 22, 2001
(86) PCT No.: PCT/EP01/07102

(30) Foreign Application Priority Data
Jun. 23, 2000 (DE) 100-29-668.8

(51) Int. Cl. C12M 1/00

(52) U.S. Cl. 435/289.1; 435/298.1

(57) ABSTRACT

The invention relates to a bioreactor for microbial conversion of substances (2) in lump and/or paste form, comprising a reactor chamber (3) which is heat-insulated in relation to the environment and which comprises at least one reactor tank (4) with an essentially U-shaped cross-section; a segmented worm conveyor (5) located in the or each reactor tank (4), coaxially in relation to said reactor tank, said segmented worm conveyor(s) rotating in the semicircular area of the U-shaped cross section (5); devices (6) for guiding gas and/or liquid and at least one supply and delivery device for each of the substances to be converted. At least a proportion of the devices (6) for guiding gas and/or liquid is located in the U-shaped area of the reactor tank (4) beneath the axle (7) of the segmented worm conveyor (5).

This invention relates to a bioreactor for the microbial conversion of lumpy and/or pasty materials and in particular for the aerobic degradation of waste materials with a significant content of organic substances.

A method and a system for the microbial conversion of organic residues have been described earlier in DE-19629129.

The system developed for implementing said method encompasses as its core element a tubular reactor thermally insulated from the environment.

The tube, extending in an essentially horizontal direction when in its primary operational position, features an essentially U-shaped cross section and contains a coaxially installed segmented worm-drive conveyor. One function of the worm-drive conveyor is to evenly fill the reactor chamber by loading the waste material from its front end in the feed direction and to uniformly distribute the material in the reactor chamber through the forward rotation of the worm screw.

After the loading process the segmented worm-drive conveyor serves to thoroughly mix the waste material to be converted, by time-controlled alternating forward and reverse rotation of the screw in and against the feed direction, with paddle-shaped segments of the conveyor moving the waste material and bringing ever changing sections of the waste material in contact with an air current that continuously flows past its top surface, the objective being the quickest possible, thorough aerobic degradation of the organic components of the waste material. The air current, heated up by bacterial reactions, exits through a heat exchanger and a filter while the recovered heat is used to preheat newly introduced air so as to further accelerate the reaction.

This earlier system concept has a drawback in that the waste material is not sufficiently mixed by the segmented conveyor to ensure the degree of surface aeration of the waste material that is needed for an optimal and near-exclusively aerobic conversion of the waste material.

It has also been found that, depending on the nature of the waste material, the paddle-shaped segments are often exposed to strong counteracting forces with the resistance being high enough to disrupt the continuous mixing process of the segmented worm-drive conveyor especially when processing pasty and highly viscous waste, potentially leading in extreme cases to transmission damage in the drive system and to bent or broken segments.

It is therefore the objective of this invention to develop a bioreactor that permits optimal exposure of the substances to be converted in the reactor to a gas such as air and that can be expected to be free of functional problems of the segmented worm-drive conveyor even when processing pasty or highly viscous substances.

This objective is achieved in inventive fashion by the characterizing features specified in the main claim 1. The characterizing features described in subclaims 2 to 19 reflect advantageous design versions of the invention.

The following will explain this invention in more detail based on two preferred implementation examples with reference to the attached drawings in which—

FIG. 1 is a schematic cross-section view of a bioreactor according to a first preferred design example of the invention;

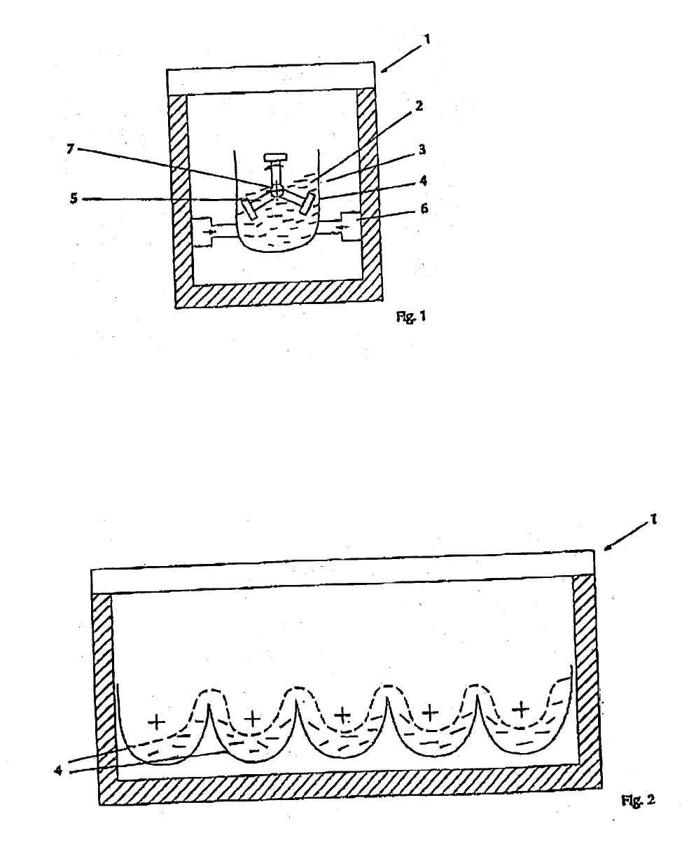

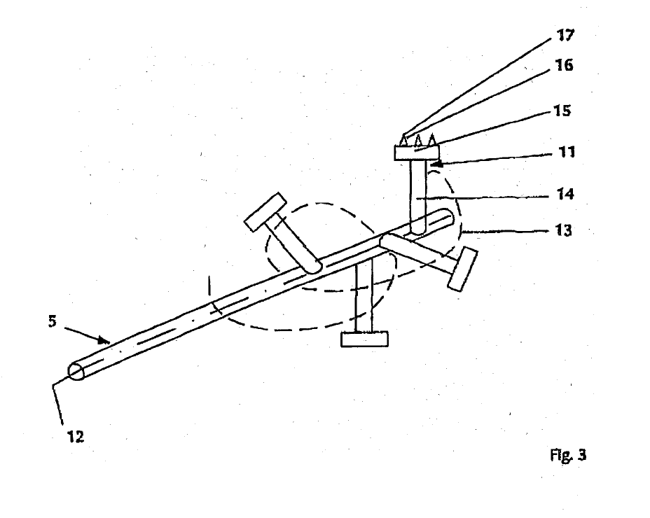

FIG. 2 is a schematic cross-section view of a bioreactor according to a second preferred design example of the invention;

FIG. 3 is an isometric illustration of the basic configuration of the segmented worm-drive conveyor;

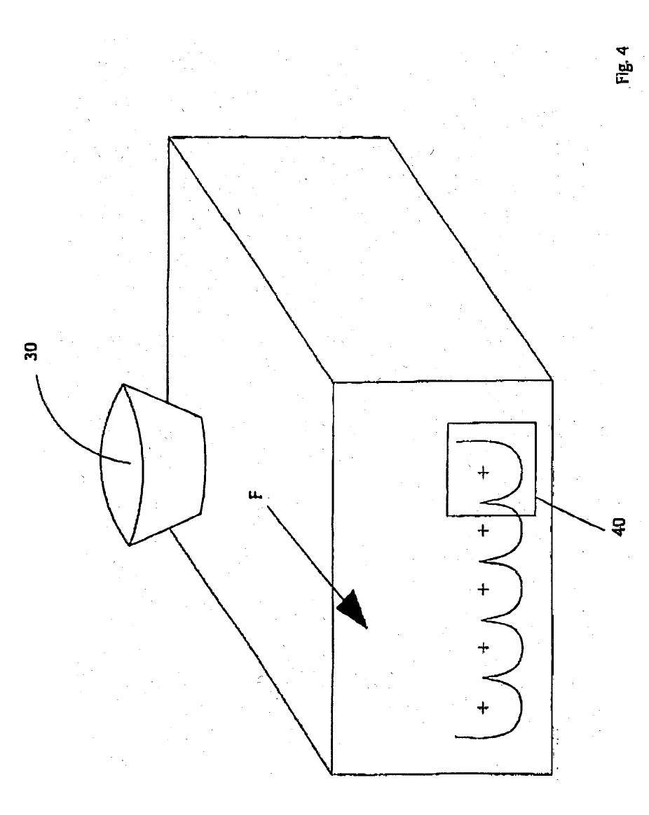

FIG. 4 is a diagrammatic perspective illustration showing the infeed and discharge of the material to be converted in a bioreactor according to the second preferred design example.

FIG. 1 is a cross-section view of a first preferred design version of a bioreactor 1 for the microbial conversion of lumpy and/or pasty substances 2 with only one reactor tank 4. The bioreactor 1 according to the invention as illustrated is a reactor for the aerophilic degradation of the organic component in lumpy and/or pasty waste materials 2. However, the bioreactor per the invention can also be employed for anaerobiotic biogas extraction or similar purposes.

As shown in the example of a multi-tank reactor illustrated in FIG. 4, the material to be converted enters the reactor via a feeder 30. The feeder may be for instance a chute mounted above the reactor tank or simply an infeed opening. The infeed opening may optionally be on the side of the front end of the reactor tank 4 and the material to be converted may be fed in via a conveyor belt or a dump truck. Extending coaxially in the longitudinal direction of the semicircular section of the U-profile of the reactor tank 4, a segmented worm-drive conveyor 5 rotates in the feed direction F, serving to evenly distribute the material 2 from the infeed throughout the reactor tank 4.

Once the reactor tank 4 has been evenly filled, which may be monitored and signaled by volume sensors mounted above the tank 4 but not illustrated, a central control unit, not shown, stops the transport motion by the segmented worm-drive conveyor 5 in the feed direction while at the same time a gas and/or fluid injection system ?6 is activated.

The primary purpose of the injection system ?6 is to bring the reaction gas needed for the conversion of the material 2 in the reactor tank into as intense a contact as possible with the surface of the material 2. According to the invention this is accomplished by positioning at least part of the gas and/or fluid injection system in the semicircular section of the reactor tank 4 underneath the shaft 7 of the segmented worm-drive conveyor for the gas and/or fluid intake or outlet.

At the same time as the gas and fluid flow through the material 2, the waste material begins to move through the segmented worm-drive conveyor 5. The segmented worm-drive conveyor 5 is equipped with conveyor segments 11 (ref. FIG. 3) that are axially arranged at an angle around a center axis 12 along a helical line 13 and preferably evenly spaced from one another. The conveyor elements 11 encompass a shaft section 14 that extends radially from the center axis 12 of the segmented worm-drive conveyor 5, as well as a headpiece 15 that extends crosswise relative to the shaft section 14 and is connected to the outer end of the shaft section 14.

The headpiece may have a suitably arched contour relative to the center axis 12 of the segmented worm-drive conveyor 5 and may be mounted along the axial pitch of the helical line 18.

In a desirable design version of the bioreactor according to the invention the arched head pieces 15 may be provided with serrations 17 protruding outward from the radial outer surface. These serrations serve to loosen any deposits of viscous substances on the inner surface of the semicircular part of the reactor tank. The material 2 introduced in the reactor tank 4 is moved by a programmed drive system of the segmented worm-drive conveyor back and forth in and against the feed direction F while being continuously tumbled by the conveyor segments 11. This programmed movement of the material and the simultaneous passage of the material through the reaction gas and through the fluids present in or added to the material bring about a very intense contact of the reaction gas with the material surfaces, initiating and completing a rapid microbial conversion of the material 2.

In the semicircular section of the reactor tank 4 the reaction gas such as air, oxygen etc. is at least in part pressure-injected in the material 2 or drawn through the material 2 by vacuum suction.

For the desired effect, part of the reaction gas is simultaneously introduced from the open topside of the material 2, thus exposing the material surfaces on all sides to a continuous influx of fresh reaction gas.

The central control unit (not illustrated) can control the microbial reaction in a manner whereby, through thermal probes mounted above the reactor tank 4, the respectively current reactor temperature is measured and the measuring signals are fed into the central control unit.

By intensifying or reducing the movement of the segmented worm-drive conveyor 5 or by increasing or decreasing the intake of reaction gas, the control unit can effectively and selectively regulate the microbial reaction, thereby countering overreaction such as burns as much as inadequate or altogether failing reaction.

The feed-in of the reaction gas into the semicircular section of the reactor tank 4 underneath the shaft 7 of the segmented worm-drive conveyor 5 either by pressure-injection into or vacuum suction through the material 2 moving in the reactor tank 4 is suitably accomplished by means of devices ?6 provided with a terminal piece configured in the form of a perforated plate and flush-mounted in the wall of the reactor tank.

However, it is equally possible to introduce or extract gas and fluids into or, respectively, from the material 2 in other ways, for instance by means of single- or multi-orifice nozzles protruding into the reactor tank 4.

To control the microbial reaction, the segmented worm-drive conveyor can be operated at time intervals, for instance moving in the feed direction F for a time span T1, then in the opposite direction for a time span T2.

In the case of the bioreactor according to the first design example, incorporating only one reactor tank 4, the time periods T1 and T2 will be identical in length to ensure that the material 2 in the reactor tank will indeed only be moved back and forth and thoroughly mixed.

In the case of the bioreactor according to the second design example, schematically illustrated in FIG. 2 and 4 and incorporating several parallel, side-by-side reactor tanks 4, the concept provides, in addition to the movement of the segmented worm-drive conveyors, for the gradual progression of the inserted material from one tank over its lateral edge into the adjoining tank whereby, from the initial loading of the material at the front end of the first tank to the exiting of the converted substances at the tail end of the last tank or over the lateral edge of the last tank, a continuous or quasi-continuous conversion process takes place. For such forwarding of the fed-in material it is necessary for the time period T2, i.e. the reverse movement, to be shorter than the time period T1 in which the material advances.

Optimal microbial conversion is obtained with low rotational speeds of the screw of the segmented worm-drive conveyor 5 at up to 10 revolutions per hour.

Optimal energy economy is achieved by extracting from the reaction gas, heated up by the reaction-generated temperature build-up, any excess heat by way of a heat exchanger and using that thermal energy to heat up the incoming reaction gas, thus further accelerating the microbial action.

For an accelerated initiation of the microbial process in newly introduced material it is desirable to prime such newly fed-in material by additionally seeding it with previously processed, microbe-infiltrated material, or by not completely discharging the material of the preceding batch, thus priming the newly loaded material.

It may be desirable especially when discharging the material to tilt at least the one reactor tank 4 or the entire bioreactor in the longitudinal direction by up to 90°.

Compared to conventional bioreactors, the advantage of the bioreactor according to this invention lies in the much more intense contact between the substances to be converted and the reaction gas, permitting substantially better control as well as shorter reaction times.

Moreover, the material is fluffed up better which, combined with the action of the conveyor segments, virtually eliminates functional blockage of the segmented worm-drive conveyor or breakdowns due to clogging or similar problems.

1. Bioreactor (1) for the microbial conversion of lumpy and/or pasty materials (2), incorporating a reaction chamber (3) thermally insulated from the environment and including at least one reactor tank (4) with an essentially U-shaped cross-sectional profile, a segmented worm-drive conveyor (5) coaxially extending in the longitudinal direction in each reactor tank (4) and rotating in the semicircular part of the U-shaped profile, with gas- and/or fluid-carrying devices (?6), as well as at least each one infeed and discharge device (30, 40) for the materials to be converted, characterized in that at least part of the gas- and/or fluid-carrying devices (?6) are positioned in the semicircular section of the reactor tank (4) underneath the shaft (7) of the segmented worm-drive conveyor (5).

2. Bioreactor as in claim 1, characterized in that the gas and/or fluid introduced by the gas- and/or fluid-carrying devices (?6), located in the semicircular section, is pressure-injected into the material (2) moving in the reactor tank (4).

3. Bioreactor as in claim 1, characterized in that the gas- and/or fluid-carrying devices (?6), located in the semicircular section, draw the gas and/or fluid through the material (2) moving in the reactor tank (4) by applying vacuum suction.

4. Bioreactor as in one or several of the preceding claims, characterized in that the gas- and/or fluid-carrying devices (?6) located in the semicircular section are provided with an end piece in the form of a perforated plate flush-mounted in the wall of the reactor tank (4).

5. Bioreactor as in at least one of the claims 1 to 3, characterized in that the gas- and/or fluid-carrying devices (?6) located in the semicircular section are in the form of single- or multi-orifice nozzles protruding into the inside of the reactor tank (4).

6. Bioreactor as in at least one of the preceding claims, characterized in that at least two reactor tanks (4) are positioned parallel to each other in a side-by-side configuration.

7. Bioreactor as in at least one of the preceding claims, characterized in that the segmented worm-drive conveyor (5) encompasses conveyor segments (11) mounted at an angle around its center axis (12) along a helical line (13) and axially spaced from one another.

8. Bioreactor as in at least one of the preceding claims, characterized in that the conveyor elements (11) include a shaft section (14) radially extending from the center axis (12) of the segmented worm-drive conveyor (5) as well as a head piece (15) connected to the outer end of and extending in a transverse direction relative to said shaft section (14).

9. Bioreactor as in claim 8, characterized in that the headpieces (15) of the conveyor segments (11) are mounted at the outer end of the shaft sections (14) in an arched configuration relative to the center axis (12) of the segmented worm-drive conveyor (5).

10. Bioreactor as in claim 8 and/or 9, characterized in that the headpieces (15) are arranged in the direction of the pitch of the helical line (13).

11. Bioreactor as in at least one of the claims 8 to 10, characterized in that the radial outer surface of each headpiece (15) connects to outward-protruding serrated elements (17).

12. Bioreactor as in at least one of the preceding claims, characterized in that the segmented worm-drive conveyor(s) (5) is/are driven in programmed fashion.

13. Bioreactor as in claim 12, characterized in that the segmented worm-drive conveyor(s) (5) is/are operated at time intervals and is/are driven in the feed direction (F) for a time period (T1) and then against the feed direction (F) for a time period (T2).

14. Bioreactor as in claim 13, characterized in that the time periods (T1) and (T2) are essentially identical.

15. Bioreactor as in claim 13, characterized in that the time period (T2) is shorter than the time period (T1).

16. Bioreactor as in at least one of the claims 12 to 15, characterized in that the segmented worm-drive conveyor(s) (5) is/are driven at a low rotational speed of <10 revolutions per hour.

17. Bioreactor as in at least one of the preceding claims, characterized in that the infeed device (30) is positioned at the feed-in front end of the (first) reactor tank (4) and the discharge device is positioned behind the tail end or next to the open transverse side of the (last) reactor tank (4).

18. Bioreactor as in at least one of the preceding claims, characterized in that the reactor tank(s) (4) or the entire bioreactor (1) can be tilted from its/their primary operational horizontal position in the longitudinal direction by up to 90°.

19. Bioreactor as in at least one of the preceding claims, characterized in that it includes at least one heat-exchanger and filtering system for extracting heat from, and filtering, the exiting gas and for preheating the newly introduced gas.
